(19) United States
(12) Patent Application Publication
(10) Pub. No.: US 2011/0320951 A1
(43) Pub. Date: Dec. 29, 2011

(54) Methods for Controlling and Managing an Interactive Dialog, Platform and Application Server Executing these Methods

(75) Inventors: Eric PAILLET, Tregastel (FR); Jean-François Gyss, Rospez (FR)

(73) Assignee: France Telecom, Paris (FR)

(21) Appl. No.: 13/149,840

(22) Filed: May 31, 2011

(30) Foreign Application Priority Data
May 31, 2010 (FR) 1054203

(51) Int. Cl. G06F 3/01

(52) U.S. Cl. 715/734

(57) ABSTRACT

In this method for controlling an interactive dialog, the platform sends the application server intermediate requests comprising data representative of a part only of the interaction between the user and the terminal, prior to the end of the interaction, to which the application server responds via intermediate responses. This method therefore anticipates the complete user input and offers a faster and more interactive service.

### RELATED APPLICATIONS

This application claims the priority of French patent application Ser. No. 10/54203 filed May 31, 2010, the entire content of which is hereby incorporated by reference.

### BACKGROUND OF THE INVENTION

The invention relates to the field of interactive communication services, where a user sets up a dialog with an application server via a terminal to obtain information or launch a service.

In a known manner, these dialogs can be vocal, textual, or multimode.

In the case of a textual dialog, the user inputs (i.e. enters) a request on keyboard, this request being transmitted to the application server which returns a response for example in the form of an HTML page generated by a dialog manager.

In the case of a vocal dialog, a vocal platform interfaces between the terminal of the user and the dialog manager, this vocal platform comprising a vocal recognition engine capable of detecting the end of an interaction between the terminal and the user and sending to the application server a request comprising the information representative of the user vocal input.

This application server comprises a semantic analyser and a dialog manager capable of generating a VoiceXML page used by the vocal platform to return a message to the user. It may also comprise a semantic analyser, the latter not being indispensable, in particular in the case of inputs by keywords.

Recent developments have improved the interface between the terminal and the user.

Graphic conversational agents, also called <<avatars>> are known in particular, and are capable of assisting the user in preparing his request.

Also, search engines propose showing the user input requests pre-registered in a database on the basis of first characters input by the user.

If these techniques improve effectively and considerably interaction between the user and the terminal, precisely, in setting up the request of the user, they do not improve the dialog between a user and an application server.

### SUMMARY OF THE INVENTION

One object of the invention is to provide a mechanism for improving the interactive dialog between a user and an application server.

A first aspect of the invention concerns a control method for controlling an interactive dialog which may be executed by a platform to control an interactive dialog between a user of a terminal and an application server, the platform, the terminal and the application server being capable of communicating via a telecommunication network, this method comprising:

a detection step of detecting the end of a user input (or entry); and

a transmission step, following the detection, of sending a so-called end of input request to the application server, the request comprising data representative of the interaction.

This method also comprises at least one transmission step of sending an intermediate request to the application server, prior to the end of the interaction, the intermediate request comprising data representative of a part only of the interaction.

In particular, the method also comprises at least one receiving step, prior to the end of the interaction, of an intermediate response in response to the intermediate request.

Another aspect of the invention provides a platform comprising communication means with a terminal and communication means with an application server, this platform comprising:

detection means for detecting the end of an interaction between the user and the terminal; and

transmission means for sending, following the detection, a so-called end of input request to the application server, the request comprising data representative of the interaction.

This platform is remarkable in that the transmission means are capable of sending at least one intermediate request to the application server, prior to the end of the interaction, the intermediate request comprising data representative of a part only of the interaction.

In particular, the platform also comprises receiving means for receiving, prior to the end of the interaction, at least one intermediate response in response to at least one intermediate request.

In this document, the following definitions are used:
<<input>>, <<user request >> or <<user interaction>>: expression formulated in writing or orally consisting of a chain of characters and/or of words;
<<request>>: interrogation addressed by the terminal to the server and consisting of a processing request or an information request.
<<interaction>>: exchange comprising a user input and the response from the server;
<<dialog>>: set of interactions (requests of the user and responses from the server).

In general, the control method and the platform according to the invention enable to send the application server intermediate requests without waiting for the end of the input between the user and his terminal.

The invention therefore anticipates the complete user input and offers a more rapid and interactive service.

Another aspect of the invention is directed to a management method for managing an interactive dialog which may be executed by an application server, this method comprising:

a receiving step of receiving a so-called end of input request comprising data representative of an interaction between a user and a terminal; and

a transmission step of sending an end of input response in response to said request.

This method also comprises, prior to receipt of the end of input request, at least:

one receiving step of receiving an intermediate request comprising data representative of a part only of the interaction; and

one transmission step of sending an intermediate response in response to the intermediate request.

Another aspect of the invention provides an application server comprising:

a dialog manager;

receiving means for receiving a so-called end of input request comprising data representative of an interaction between a user and a terminal; and

transmission means for sending an end of input response in response to said request.

This application server comprises means for receiving, prior to receipt of the end of input request at least one intermediate request comprising data representative of a part only of the interaction and means for sending an intermediate response in response to the intermediate request.

The management method for managing an interactive dialog and the application server according to the invention are highly advantageously capable of sending to the user intermediate responses in response to the intermediate requests prior to the end of the dialog.

In a particular embodiment of the invention, an intermediate request may comprise information representative of the interaction between the user and his/her terminal since the transmission of the last intermediate request.

Otherwise expressed, in this embodiment, the complete input of the user (vocal or textual) corresponds to the concatenation of information corresponding to each intermediate request.

In another embodiment, at least one request (specifically an intermediate request or the end of input request) combines all the interaction between the user and the terminal until the transmission of this request.

The invention applies irrespective of the modality (vocal, textual, multimode) used in the dialog between the user and his/her terminal.

For example, when the user interacts vocally with his/her terminal, the intermediate request transmission step can be conducted after detection of each end of word pronounced by the user.

Detecting an end of a word can be determined by a silence of duration at least equal to the <<complete-timeout>> duration defined by MRCP protocol (Media Resource Control Protocol).

In a known manner, this value defines the duration of silence beyond which it is considered that the user has terminated a word, whereas the <<incomplete-timeout>> value (defined by MRCP protocol) describes the duration of silence beyond which it is considered that the user has terminated his/her input vocal.

When the user interacts with a keyboard of his/her terminal (textual modality), the intermediate request transmission step can be conducted after detection of each end of word input by the user or after detection of each character input by this user.

Reference is made here to the standard T140 used in the context of instant messaging, this type of mechanism never having been executed within the scope of an interaction between a user and an application server.

In a particular embodiment, the different steps of the control method for controlling interactive dialogs are determined by instructions of computer programs.

Similarly, in a particular embodiment of the invention, the different steps of the management method for managing interactive dialogs are determined by computer program instructions.

Another aspect of the invention provides a computer program on a data medium, this program being suitable for execution by a computer, this program comprising instructions adapted to implement the steps of the control method or of the management method such as mentioned hereinabove.

This program may use any programming language, and be in the form of source code, object code, or intermediate code between source code and object code, such as in a partially compiled form, or in any other desirable form.

Another aspect of the invention provides a data medium readable by a computer, and comprising computer program instructions such as mentioned hereinabove.

The data medium can be any entity or device capable of storing the program. For example, the medium may comprise storage means such as ROM, for example a CD ROM or a ROM with microelectronic circuit, or even magnetic recording means, for example a disc (floppy disc) or hard drive.

Also, the data medium can be a transmissible medium such as an electric or optical signal, that may be conveyed via an electrical or optical cable, by radio or by other means. The program according to the invention can be in particular downloaded onto a network of Internet type.

Alternatively, the data medium can be an integrated circuit in which the program is incorporated, the circuit being adapted to execute or to be used in the execution of the method in question.

### BRIEF DESCRIPTION OF THE DRAWINGS

Other characteristics and advantages of the invention will emerge from the following description in reference to the attached drawings which illustrate an embodiment thereof devoid of any limiting character.

In the figures:

FIG. 1 illustrates a platform and an application server in accordance with a particular embodiment of the invention;

FIG. 2 schematically illustrates the material architecture of the platform of FIG. 1;

FIG. 3 illustrates in the form of an organigram the main steps of a control method for controlling interactive dialogs in accordance with a particular embodiment of the invention;

FIG. 4 illustrates the material architecture of an application server in accordance with a particular embodiment of the invention;

FIG. 5 illustrates in the form of an organigram the main steps of a management method for managing interactive dialogs in accordance with a particular embodiment of the invention; and

FIGS. 6A to 6C illustrate requests transmitted by a platform in accordance with the state of the art and by a platform in accordance with a particular embodiment of the invention.

### DETAILED DESCRIPTION OF THE DRAWINGS

FIG. 1 illustrates a terminal TRM, a platform PM and an application server SA in accordance with a particular embodiment of the invention.

The user interacts with his/her terminal by means of a vocal interface VI (via a microphone), or a keyboard KB. The sound messages are returned by speakers SPK.

The screen of his terminal displays a text zone ZT and a graphic conversational agent (avatar) AV.

The terminal, the platform and the application server SA communicate via a telecommunications network shown by arrows.

In the embodiment described here, the platform PM is a multimode platform. It comprises, as is known, a vocal recognition module MRV and a vocal synthesis module SV.

In this example, the application server SA comprises a semantic analyser AS and a dialog manager module MGD. The semantic analyser is optional; it may also form part of the dialog manager module MGD.

In the embodiment described here, when the user interacts with his/her terminal TRM by means of the keyboard KB, the characters input in the text zone ZT are transmitted, character by character, or word by word, to the multimode platform PM.

In the same way, the vocal inputs of the user are transmitted in real time to this multimode platform.

According to the invention, the multimode platform PM does not wait for the end of the dialog to communicate the content of the interaction between the user and his/her terminal TRM to the application server SA.

More precisely, in the embodiment described here, after each word pronounced by the user the multimode platform PM sends an intermediate request RQI to the application server SA comprising this word.

In the same way, after each character or word input by the user via the keyboard, the multimode platform PM sends a request RQI comprising this character or this word to the application server SA.

Also, when the multimode platform PM detects the end of a user input (either by a long silence in the case of a vocal dialog, or by a carriage return within the scope of a textual dialog), the multimode platform PM sends an end of input request RQFS to the application server.

In the embodiment described here this end of input request RQFS goes over the entire dialog between the user and his/her terminal.

As a variant it could for example go over only the end of the user input, since the last transmission of an intermediate request.

According to the invention, the application server SA responds to each of the intermediate requests RQI by an intermediate response RPI and to the end of input request RQFS by an end of input response RPFS.

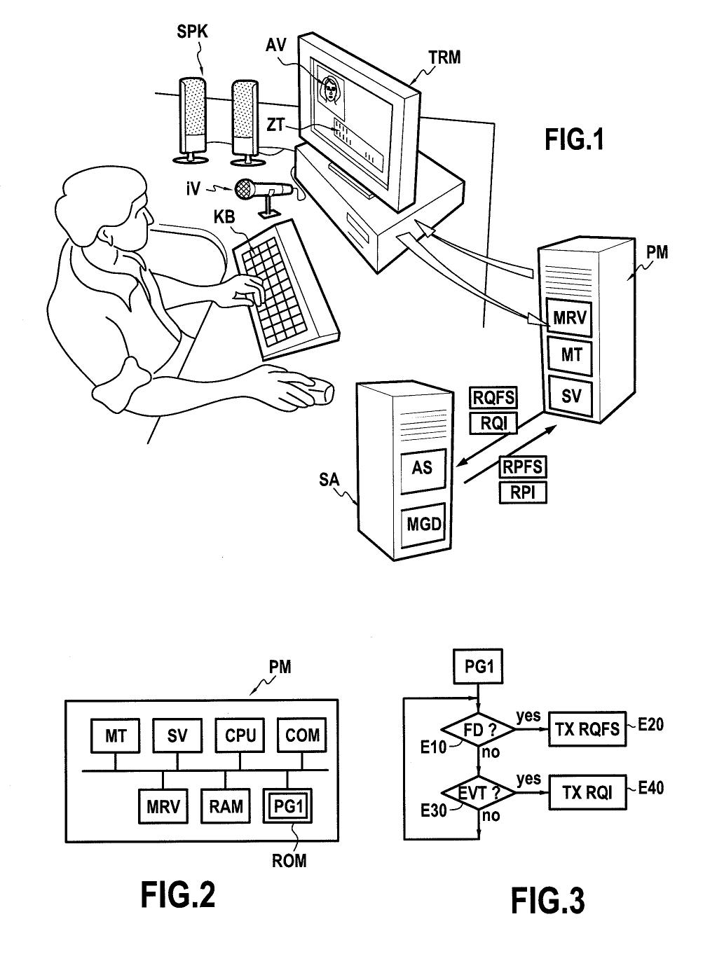

FIG. 2 illustrates the material architecture of the multimode platform PM.

In the embodiment described here this multimode platform PM comprises the material architecture of a computer.

It comprises a CPU processor, communication means COM, a read-only memory of ROM type and a random access memory of RAM type.

It also comprises a vocal synthesis module SV and a vocal recognition module MRV.

The vocal recognition module MRV is capable of recognising the words pronounced by the user and of transmitting them to the application server SA in the requests RQI, RQFS.

The vocal synthesis module SV is capable of generating a message destined for the user.

In a particular embodiment of the invention, the multimode platform PM comprises an interpreter of VoiceXML pages sent by the application server SA, the interpreted data being provided on input of the vocal synthesis module SV. Other exchange formalisms may be put in place between the application server SA and the multimode platform PM.

In the embodiment described here, the multimode platform PM also comprises a module MT capable of transmitting to the application server SA the characters or the words input by the user by means of the keyboard KB in intermediate requests RQI and a Web server, not shown, capable of generating a Web page displayable by the user by means of a navigator.

The read-only memory of ROM type constitutes a recording medium according to the invention. It memorises a computer program comprising instructions for implementing a method of interactive dialogs according to the invention the principal steps of which will now be described in reference to FIG. 3.

FIG. 3 illustrates the main steps of a management method for managing an interactive dialog according to the invention, this method being executed by the multimode platform PM.

This method comprises a first step E10 during which the multimode platform PM detects if the textual or vocal dialog between the user and his/her terminal TRM is terminated.

If this is the case, the result of the test E10 is positive and during a step E20 the multimode platform PM sends an end of input request RQFS to the application server SA.

In this example, this end of input request RQFS comprises the entire input between the user and his/her terminal TRM.

As long as the input is not terminated, the result of the test El0 is negative and during a step E30 the multimode platform PM detects if an event EVT requires the transmission of an intermediate request RQI to the application server SA.

In the embodiment described here an event EVT is constituted by:
detecting a character or a word input by the user; or
detecting a sufficiently long silence (for example of <<complete-timeout duration>>) between two words or between two groups of words input by the user.

If this is the case, the result of the step E30 is positive and during a step E40 this step is followed by sending an intermediate request RQI comprising the dialog of the user with his/her terminal, since the transmission of the last intermediate request RQI.

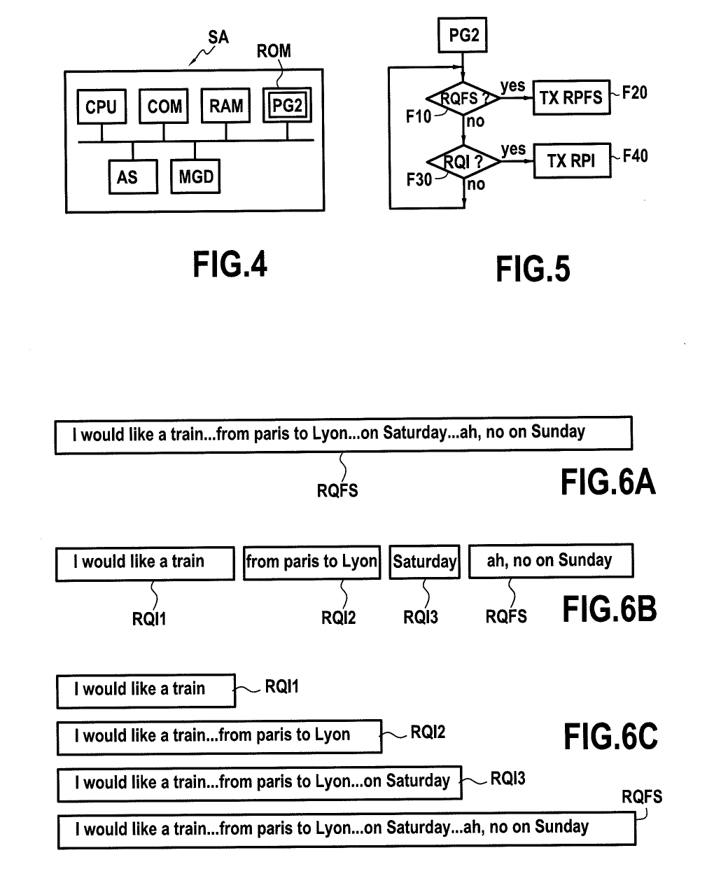

FIG. 4 illustrates the material architecture of the application server SA.

In this example, the application server mainly comprises a CPU processor, communication means COM, a read-only memory of ROM type, a random access memory RAM, a syntactic analyser AS and a dialog manager module MGD.

The read-only memory called ROM constitutes a recording medium according to the invention.

This medium memorises a computer program PG2, the principal steps of which will now be described in reference to FIG. 5.

FIG. 5 illustrates in the form of an organigram the main steps F10 to F40 of a management method for managing interactive dialogs which can be executed by an application server SA.

During a step F10, the application server SA determines if it has received an end of input request RQFS.

If this is the case, it responds to this request by an end of input response RPFS during a step F20.

But, according to the invention, the dialog management method also comprises a step F30 during which the application server SA determines if it has received an intermediate request RQI.

If this is the case, it responds to this intermediate request RQI by sending an intermediate response RPI during a step F40.

FIG. 6A illustrates an end of input request of in accordance with the state of the art, within the scope for example of a train booking service.

In the state of the art, when a user inputs a request, whether textual or vocal, the multimode platform PM waits for the end of the user input to send a request RQFS comprising the entire input to the application server.

FIG. 6B illustrates a possible implementation of the invention in which intermediate requests RQI1, RQI2 and RQI3 as well as the end of input request RQFS are sent by the multimode platform, to the application server, as soon as silence or a space is detected.

In this example, the end of input request RQFS comprises only the part of the request pronounced or input by the user since the transmission of the last intermediate request RQI3.

On receipt of an intermediate request RQI1, RQI2 and RQI3, the application server AS may send intermediate responses to the user to improve interaction.

For example, on receipt of an intermediate request RQI2 it may propose all the trains running from Paris to Lyon, then, after receipt of the request RQI3, retain in the list of proposed trains only those running on Saturday. Finally, on receipt of RQFS, the list will be updated with those trains running only on Sunday.

In reference to FIG. 6C, the invention may also propose to send, in each intermediate request RQI1, RQI2 and RQI3, the entire input until the transmission of this request.

The expert will understand that these embodiments differ from the prior art in that the requests are sent prior to the end of the input.

By way of variant, some intermediate requests may comprise only the part of the request input or pronounced by the user since the transmission of the intermediate request, and other may combine the entire request input or pronounced until the transmission of this request.

In the embodiment described hereinabove, the multimode platform PM is implemented in the form of a server communicating with the terminal TRM. In another embodiment realisation in which the interaction is written, the platform may be incorporated into the user terminal.

1. A method for controlling an interactive dialog which can be executed by a platform for controlling an interactive dialog between a user of a terminal and an application server, the platform, the terminal and the application server being capable of communicating via a telecommunication network, wherein the method comprises:
a step of detecting the end of an interaction between said user and said terminal;
a step of sending, following said detection, a so-called end of input request to said application server, said request comprising data representative of said interaction; and
prior to the end of said interaction, at least one step of sending an intermediate request to said application server, the intermediate request comprising data representative of a part only of said interaction, and at least one step of receiving an intermediate response in response to said intermediate request.

2. The control method according to claim 1, wherein said intermediate request comprises information representative of said interaction between the user and the terminal since the transmission of the last intermediate request.

3. The control method according to claim 1, wherein at least one of said requests comprises information representative of the entire said interaction between the user and the terminal until the transmission of this request.

4. The control method according to claim 1, wherein the user vocally interacts with said terminal, wherein said step of sending said intermediate request is performed after detection of each end of word or group of words pronounced by said user.

5. The control method according to claim 4, wherein detection of a word or of a group of words is determined by a silence of duration at least equal to the complete-timeout duration defined by MRCP protocol.

6. The control method according to claim 1, wherein the user interacts with a keyboard with said terminal, and wherein said step of sending an intermediate request is performed after detection of each end of word input by said user.

7. The control method according to claim 1, wherein the user interacts with a keyboard with said terminal, and wherein said step of sending an intermediate request is performed after the detection of each character input by said user.

8. A platform comprising communication means with a terminal and communication means with an application server, wherein the platform comprises:
detection means for detecting the end of an interaction between said user and said terminal; and
transmission means, for sending following said detection, a so-called end of input request to said application server, said request comprising data representative of said interaction;
wherein said transmission means are configured for sending at least one intermediate request to said application server, prior to the end of said interaction, the intermediate request comprising data representative of a part only of said interaction, and wherein the platform comprises receiving means for receiving, prior to the end of said interaction, at least one intermediate response in response to said at least one intermediate request.

9. A computer program comprising instructions for executing the steps of the control method according to claim 1, when said program is executed by a computer.

10. A recording medium readable by a computer on which is registered a computer program comprising instructions for executing the steps of the control method according to claim 1.

11. A method for managing an interactive dialog which can be executed by an application server, wherein the method comprises:
a step of receiving a so-called end of input request comprising data representative of an interaction between a user and a terminal;
a step of sending an end of input response in response to said request; and
prior to receipt of said end of input request, at least:
one step of receiving an intermediate request comprising data representative of a part only of said interaction; and
one step of sending an intermediate response in response to said intermediate request.

12. An application server comprising:
a dialog manager;
means for receiving a so-called end of input request comprising data representative of an interaction between a user and a terminal;
means for sending an end of input response in response to said request; and
means for receiving, prior to receipt of said end of input request, at least one intermediate request comprising data representative of a part only of said interaction and means for sending an intermediate response in response to said intermediate request.

13. A computer program comprising instructions for executing the steps of the management method according to claim 11 when said program is executed by a computer.

14. A recording medium readable by a computer on which is registered a computer program comprising instructions for executing the steps of the management method according to claim 11.
